(19) United States
(12) Patent Application Publication
(10) Pub. No.: US 2025/0057717 A1
(43) Pub. Date: Feb. 20, 2025

(54) JOINT TRACTION DEVICE AND METHOD OF USE

(71) Applicant: Brian Jacob Melancon, Montgomery, TX (US)

(72) Inventor: Brian Jacob Melancon, Montgomery, TX (US)

(21) Appl. No.: 18/810,409

(22) Filed: Aug. 20, 2024

Related U.S. Application Data
(60) Provisional application No. 63/520,646, filed on Aug. 20, 2023.

(51) Int. Cl. A61H 1/02

(52) U.S. Cl. CPC A61H 1/0222; A61H 1/0237; A61H 2201/0192; A61H 2201/1253; A61H 2201/149; A61H 2201/1611; A61H 2201/1642; A61H 2201/169

(57) ABSTRACT

A multiple joint traction system designed for home use, enabling effective traction therapy for the lumbar spine, cervical spine, knee, and hip joints is provided. The system comprises a support frame with a head support member and a foot support member, a bed, a pulley system, and cordage that connects a handle to joint restraints. The user pulls the handle to apply traction to the restrained joint. The device may include straps or slings to secure the user's limbs or neck, allowing for controlled traction. An optional attachment provides targeted knee and hip traction by positioning the leg in a flexed position. The system is designed for ease of use, safety, and effectiveness, allowing users to perform therapeutic exercises in the comfort of their own beds without the need for professional supervision.

### CROSS-REFERENCE TO RELATED APPLICATION

This application claims the benefit of U.S. Provisional Patent Application No. 63/520,646, filed Aug. 20, 2023, which is incorporated by reference herein in its entirety.

### COPYRIGHT AND TRADE DRESS NOTICE

A portion of the disclosure of this patent document contains material that is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### BACKGROUND

### 1. Field of the Invention

The present invention relates generally to therapeutic systems and methods for treating joint pain in the human body, and more specifically, to a multiple joint traction system designed to provide targeted traction therapy for the lumbar, cervical, knee, and hip joints.

### 2. Description of Related Art

This background information is intended to further educate the reader as to additional aspects of the prior art and may present examples of specific aspects of the prior art that is not to be construed as limiting the disclosure of the present application.

Traction therapy involves the application of a pulling force to separate joint surfaces, with the goal of reducing pain and increasing mobility. This type of therapy is commonly used by healthcare professionals such as physical therapists and chiropractors to treat various conditions, such as spinal decompression, osteoarthritis, and joint stiffness.

Traction therapy has been widely used in clinical settings, particularly for lumbar and cervical spine issues. Existing devices for home use, however, often present significant limitations in terms of ease of use, safety, and effectiveness. For instance, inversion tables use gravity to apply traction, requiring the user to hang upside down, which can be uncomfortable and risky for individuals with certain medical conditions. Other devices employ mechanical cranks or pulleys to provide traction but necessitate the user to lie on the floor, making them unsuitable for those with mobility issues.

Cervical traction devices in the market range from door-mounted slings to motorized systems, many of which are either uncomfortable or require professional supervision. Additionally, there are very few effective solutions for home-based traction of the knee and hip joints. The available devices for these joints are typically designed for clinical use and often rely on complex electronic or hydraulic systems, making them impractical for home use.

The limitations of these existing devices highlight the need for a versatile, user-friendly traction system that can be safely and effectively used in the comfort of the user's own bed. The present invention seeks to address these shortcomings by providing a home traction system that is easy to use, does not require professional supervision, and can be applied to multiple joints, including the lumbar and cervical spine as well as the knee and hip joints.

Accordingly, there exists a need for a multiple joint traction system designed to provide targeted traction therapy for the lumbar, cervical, knee, and hip joints.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

The present disclosure is directed to a multiple joint traction system designed for home use, offering an effective, user-friendly solution for providing therapeutic traction to the lumbar spine, cervical spine, knee, and hip joints. The system addresses the limitations of existing home traction devices by enabling users to perform traction therapy in the comfort and convenience of their own beds, eliminating the need to get down on the floor or use complex machinery.

The traction system comprises two primary support frames that are positioned at the head and foot of the bed. These frames are securely held in place by the bed structure, with no need for direct attachment to the bed frame. The system utilizes a pulley mechanism connected to a handle, which, when operated by the user, generates a traction force. This force is applied to the user's limbs or neck through ankle straps or a neck sling, thereby providing targeted traction to the desired joint.

The traction system is adaptable to various configurations, allowing for lumbar, cervical, knee, and hip traction. For lumbar and cervical traction, the system employs a pulley system that directs the force along the spine or neck, effectively relieving pressure on the vertebrae and surrounding muscles. For knee and hip traction, an additional attachment can be used to apply force to the knee in a flexed position, optimizing pain relief and joint mobility.

The design of the traction system emphasizes safety, ease of use, and effectiveness, making it suitable for individuals who require regular traction therapy but may have difficulty accessing professional care or using conventional home devices. The system's versatility and the ability to perform multiple types of traction make it a valuable tool for managing joint pain and improving mobility at home.

To further clarify the advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a rear right perspective view of a joint traction device, in accordance with an embodiment of the present disclosure;

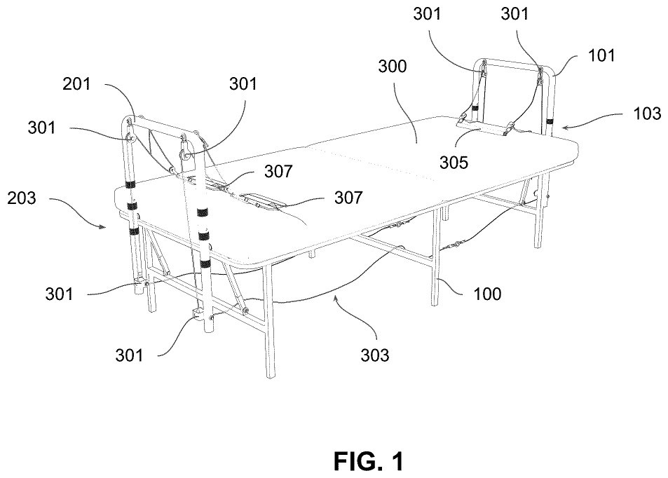

FIG. 2 is a front right perspective view of the joint traction device;

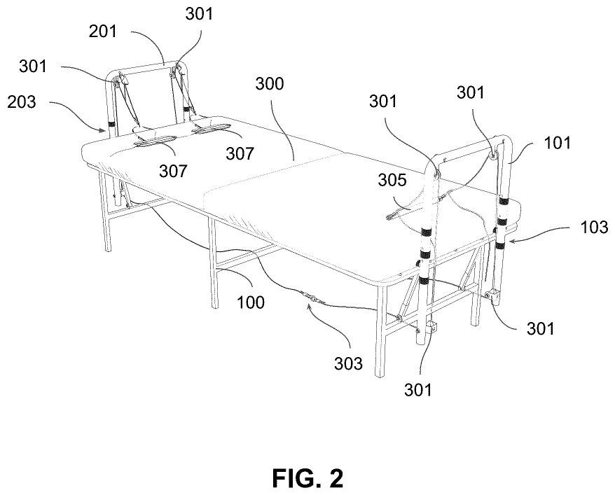

FIG. 3 is a front view of the joint traction device;

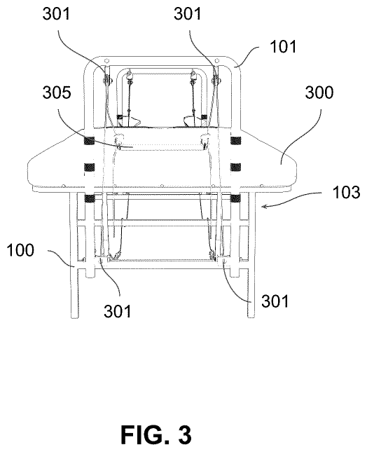

FIG. 4 is a rear view of the joint traction device;

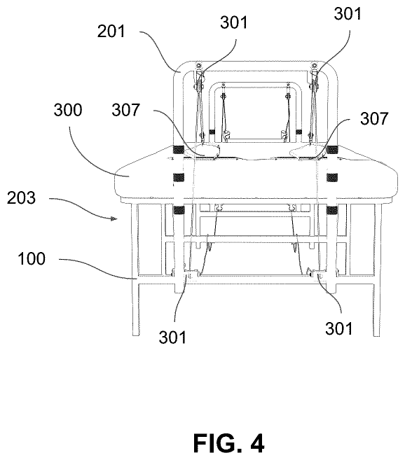

FIG. 5 is a right side view of the joint traction device;

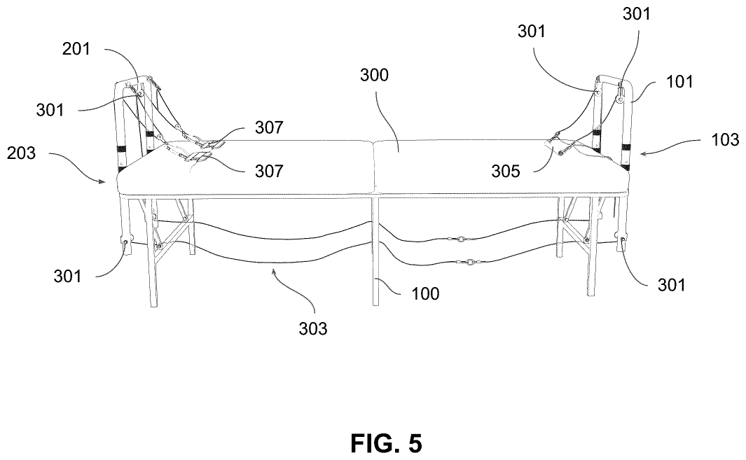

FIG. 6 is a left side view of the joint traction device; and

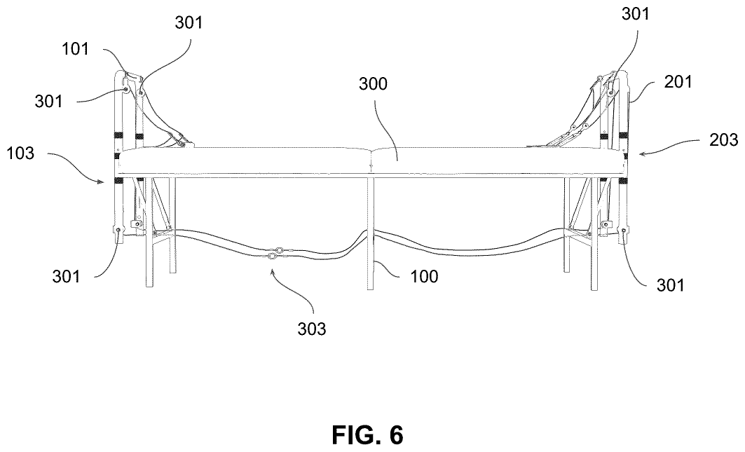

FIG. 7 is a top view of the joint traction device.

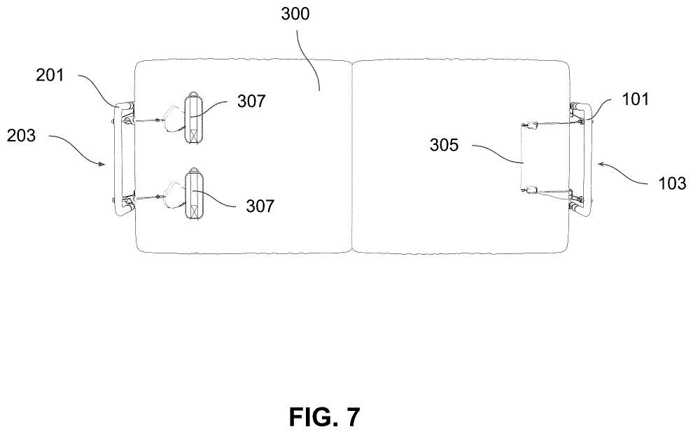

While the device of the present application is subject to various modifications and alternative forms, specific embodiments have been shown by way of example in the drawings and are described in detail. It should be understood that the description of specific embodiments is not intended to limit the invention to the particular embodiment disclosed, but rather to cover all modifications, equivalents, and alternatives falling within the scope of the present application as defined by the appended claims.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

Illustrative embodiments of the device of the present application are provided herein. It should be appreciated that in the development of any actual embodiment, various implementation-specific decisions are required to achieve the developer's specific goals, such as compliance with system-related and business-related constraints, which vary from one implementation to another. Moreover, it should be appreciated that such a development effort might be complex and time-consuming but would nevertheless be a routine undertaking for those of ordinary skill in the art having the benefit of this disclosure.

The device should be understood, both as to its structure and operation, from the accompanying drawings, taken in conjunction with the accompanying description. Various embodiments of the device may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility, and non-obviousness.

The present disclosure provides a multiple joint traction system designed for home use, enabling users to perform effective traction therapy on the lumbar spine, cervical spine, knee, and hip joints. The system is designed for ease of use, comfort, and effectiveness, allowing users to perform therapeutic exercises in their own beds without the need for assistance from a healthcare professional or the use of complex, floor-based equipment.

The traction system of the present application comprises a support frame 100 having a head support member 101 positioned at a head end 103 of a bed 300, and a foot support member 201 positioned at a foot end 203 of the bed 300, a plurality of pulleys 301, cordage 303, a handle 305, and one or more joint restraints 307. The support frame 100 supports the bed 300 and the plurality of pulleys 301 and is configured to provide stability during use.

The head support member 101 provides support for the cervical traction mechanism. The foot support member 201 provides support for the lumbar and lower limb traction mechanisms. The head support member 101 and the foot support member 201 are configured to support one or more pulleys 301 of the plurality of pulleys.

The system uses cordage 303, which may be made of woven nylon, steel cable, or another durable material, to connect the handle 305 to the one or more joint restraints 307. A user can control the amount of traction force applied to a joint restrained by the one or more joint restraints 307 by pulling the handle 305.

For lumbar traction, the user lies on the bed 300 with the user's ankles secured by the one or more joint restraints 307. The one or more joint restraints 307 are positioned at the foot end 203 and attached to the cordage 303. The cordage 303 then runs through one or more pulleys 301 supported by the foot support member 201 and underneath the bed 300 and attaches to the handle 305 positioned at the head end 103. When the user pulls on the handle 305, the cordage 303 pulls on the one or more joint restraints 307, applying a force to the user's lower limbs. This force is translated along the spine, creating separation between the lumbar vertebrae and relieving pressure on the spinal discs and surrounding muscles.

For cervical traction, the user lies on the bed 300 with the user's head secured by the one or more joint restraints 307. The one or more joint restraints 307 are positioned at the head end 103 and attached to the cordage 303. The cordage 303 then runs through one or more pulleys 301 supported by the head support member 101 and attaches to the handle 305 positioned at the head end 103. When the user pulls on the handle 305, the user applies a pulling force to the neck creating traction along the cervical spine. This method of traction is particularly effective for relieving tension and pain in the neck and upper back.

The system may further include a leg support member connected to the support frame 100 and configured to provide support of the user's leg for knee and hip traction. The leg support member may include an adjustable support bar and a sling for the user's leg, allowing the knee to be positioned at a 90-degree angle or other desired flexion. Traction is applied by pulling the handle 305, which draws the one or more joint restraints 307 securing the user's ankle and connected to the cordage 303, thereby applying a pulling force to the knee joint. This configuration is particularly beneficial for users suffering from knee osteoarthritis or other conditions that require joint decompression.

The components of the traction system are constructed from materials selected for durability, strength, and comfort. The frames may be made from metal, plastic, wood, or any other material that provides the necessary support. The cordage, as mentioned, can be made of woven nylon, steel cable, or similar materials, ensuring a smooth and controlled application of force. The handle, neck sling, and ankle straps are made from comfortable, durable textiles or other suitable materials to prevent discomfort during use.

It should be appreciated that the multiple joint traction system of the present disclosure offers several advantages over existing home traction devices. First, the system can be easily set up and used on a standard bed, eliminating the need for floor-based devices or professional supervision. Second, the system can be configured for lumbar, cervical, knee, and hip traction, providing a comprehensive solution for multiple types of joint pain and discomfort. Third, the design allows users to perform traction exercises in the safety and comfort of their own bed, reducing the risk of falls or other injuries associated with floor-based devices. Fourth, the use of a bed-based system ensures that users can perform traction therapy in a comfortable position, which is particularly important for those with mobility issues or severe pain.

The particular embodiments disclosed herein are illustrative only, as the embodiments may be modified and practiced in different but equivalent manners apparent to those skilled in the art having the benefit of the present disclosure. It is therefore evident that the particular embodiments disclosed herein may be altered or modified, and any such variations are considered to fall within the scope of the present application. Accordingly, the protection sought herein is as set forth in the description and the appended claims as well as any other variations and modifications falling within the scope thereof.

What is claimed is:

1. A joint traction device, comprising:
a bed configured to support a user's body;
a support frame having a head support member at a head end and a foot support member at a foot end;
a plurality of pulleys connected to the support frame wherein at least one pulley is connected to the head support member and at least one pulley is connected to the foot support member;
a handle;
one or more joint restraints; and
a cordage configured to connect the handle to the one or more joint restraints by running through at least one pulley of the plurality of pulleys.

2. The joint traction device of claim 1, wherein the one or more joint restraints are ankle straps.

3. The joint traction device of claim 1, wherein the one or more joint restraints is a neck brace.

4. The joint traction device of claim 1, wherein the cordage is made from a material selected from the group consisting of woven nylon and steel cable.

5. The joint traction device of claim 1, further comprising a leg support member connected to the support frame and configured to support the user's leg.

6. The joint traction device of claim 1, wherein the support frame is adjustable in size.

7. The joint traction device of claim 1, wherein the support frame is constructed from a material selected from the group consisting of metal, plastic, and wood.

8. A method of applying joint traction therapy, the method comprising:
securing a support frame to a bed configured to support a user's body;
connecting a handle to one or more joint restraints;
securing a joint of the user by the one or more joint restraints; and
applying a force to the joint of the user by the user pulling on the handle.

9. The method of applying joint traction therapy of claim 8, wherein the handle is connected to the one or more joint restraints via cordage and a plurality of pulleys supported by the support frame.

10. The method of applying joint traction therapy of claim 8, wherein the joint traction therapy is applied to the user's lumbar spine by securing the one or more joint restraints around the user's ankles and instructing the user to push the handle towards the foot of the bed.

11. The method of applying joint traction therapy of claim 8, wherein the joint traction therapy is applied to the user's cervical spine by securing the one or more joint restraints around the user's head and instructing the user to pull the handle towards the foot of the bed.

12. The method of applying joint traction therapy of claim 8, further comprising adjusting the height of the vertical support legs of the first and second support frames to accommodate the bed height and user preference.
